(19) United States
(12) Patent Application Publication
(10) Pub. No.: US 2009/0090342 A1
(43) Pub. Date: Apr. 9, 2009

(54) Archery release aid light apparatus

(76) Inventors: William C. Freitag, Utica, OH (US); Eric Braden, Orange, CA (US)

Correspondence Address: Patrick P. Phillips;KREMBLAS, FOSTER, PHILLIPS & POLLICK, 7632 Slate Ridge Blvd, Reynoldsburg, OH, 43068, US

(21) Appl. No.: 12/287,587

(22) Filed: Oct. 9, 2008

Related U.S. Application Data
(60) Provisional application No. 60/997,933, filed on Oct. 9, 2007.

(51) Int. Cl. F41B 5/18; F21V 33/00

(52) U.S. Cl. 124/35.2; 362/109; 124/32

(57) ABSTRACT

A small, light-weight, portable lighting device that attaches to an archery release aid providing sufficient illumination to assist the archer in attaching the release aid to the bowstring or loop and/or the arrow to the nocking position of the bowstring is provided. The light apparatus has a housing, a power supply, a button and a lighting device. The housing has a first outer wall component and a second outer wall component, with each of the first and second outer wall components attached to one another. The housing has an interior cavity, and a first aperture and a second aperture. The power supply is preferably located inside the housing. The button is preferably depressable, and is retained in the cavity, with the button being visible through the first aperture. Preferably the button projects through the first aperture, and the lighting device projects through the second aperture.

### CROSS-REFERENCES TO RELATED APPLICATIONS

This application claims the benefit of U.S. Provisional Application No. 60/997,933 filed Oct. 9, 2007.

### BACKGROUND OF THE INVENTION

1. Field of the Invention

This invention relates generally to lighting devices, and more particularly one which attaches to, or is sold as an integral part of, an archery release aid.

2. Description of the Related Art

Archers hunting in low light conditions, for example, in the early morning, early evening, or in the deep woods, often have difficulty attaching a release aid to the bowstring or loop and/or setting the arrow to the nocking position of the bowstring. The nocking postion is the point along the bowstring where the nock on the arrow contacts the string. In theory, under most circumstances when shot, an arrow should be fairly level i.e. essentially perpendicular to the bowstring at rest.

A release aid is a device used in hunting for the past 40-50 years which grips the bowstring and assists in making the arrow fly in a straight path instead of at a slight angle. This is accomplished by aiding in the release of the arrow from the string. Without the use of a release aid, the arrow may fly in an undesirable angled flight path caused by the unequal pressure on the bowstring of the finger/fingers and thumb at the time of release.

Most release aids operate using a trigger that releases the bowstring from a clamp-like component of the release aid. The clamp-like component is placed on the bowstring (or a loop in the bowstring used by some hunters) before shooting of the arrow. Delay in attaching the release aid to the bowstring or loop due to poor visibility can cause the archer to miss the ideal shot at the intended target. A delayed shot at the target under non-ideal conditions may cause a complete miss or a wounding of the target instead of a kill. Until now, attempts to deal with this problem have been essentially non-existent. While one could practice to hopefully make the attachment process faster and more reliable, trying to attach a release aid in dark or dusky conditions is not a sure thing even with practice. Alternatively, a light may be turned on in the hunting blind to help see the bowstring, but it needs to be off when the string is pulled, which in essence requires a “third hand”, since one hand is holding the bow and another is holding the release aid. Leaving the light on can compromise the presence of the hunter and therefore cause the prey to flee.

It is thus apparent that the need exists for a better archery release aid light apparatus.

### SUMMARY OF THE INVENTION

In accordance with the present invention, there is disclosed an archery release aid light apparatus having a housing, a power supply, a button, a lighting device, and archery release aid light attachment means. The housing has a first outer wall component and a second outer wall component, with each of the first and second outer wall components attached to one another. The housing has an interior cavity, and a first aperture and a second aperture.

The power supply is preferably located inside the housing. The button is preferably depressable, and is retained in the cavity, with the button being visible through the first aperture. Preferably the button projects through the first aperture. The lighting device has a lighting device housing, a light emitting member, and circuitry, with the circuitry having a first component and a second component, with the first component extending from the lighting device to a location intermediate the power supply and the button. The second component extends from the lighting device to a location intermediate the power supply and the second outer wall component. The first component and the second component are each conductors. The lighting device housing preferably projects through the second aperture.

The first aperture is of a first area and the second aperture is of a second area, with the first aperture being larger in area than the second aperture. The housing has a top wall, a bottom wall, and a side wall, with the top wall being generally rectangular in shape. Preferably the first aperture is located in the top wall and the second aperture is located in the side wall. Preferably the light emitting member is a light emitting diode.

The primary object of this invention is to provide a lighting device to illuminate the attachment point of the release aid to the bowstring or loop, and the arrow to the nocking position of the bowstring, is needed.

Another object of this invention is to provide such a light that preferably is powered by a self-contained source, for example, a simple battery, so that the device is portable and not encumbered by cords associated with a remote power source.

Still another object of the invention is to provide a lighting device that preferably utilizes a light source that permits directional illumination, as well as one which operates with very low operating current so as to ensure long operational life.

Yet still another object of the invention is to provide a device that is small, light-weight, and easy to activate so it does not affect the normal function and use of the release aid. The portability, small size, light-weight, and easy activation of the lighting device allows for attachment to the release aid per the archer's preferences, for example, attachment to the left-side, right-side, top-side, or bottom-side of the release aid to accommodate the archer's anchor point, sighting method, and string hand.

Other objects and advantages of the invention will be apparent from the following description, the accompanying drawings and the appended claims.

### BRIEF DESCRIPTION OF THE DRAWINGS

FIG. 1 is a perspective view of a preferred embodiment of the lighting device of the subject invention.

FIG. 2 is a front plan view of a preferred embodiment of the lighting device of the subject invention.

FIG. 3 is bottom plan view of a preferred embodiment of the lighting device of the subject invention.

FIG. 4 is a side elevational view of a preferred embodiment of the lighting device of the subject invention.

FIG. 5 is a cross-sectional scematic view taken along line 5-5 of FIG. 4.

FIG. 6 is a side elevational view of an archery release aid incorporating the lighting device in an operative position.

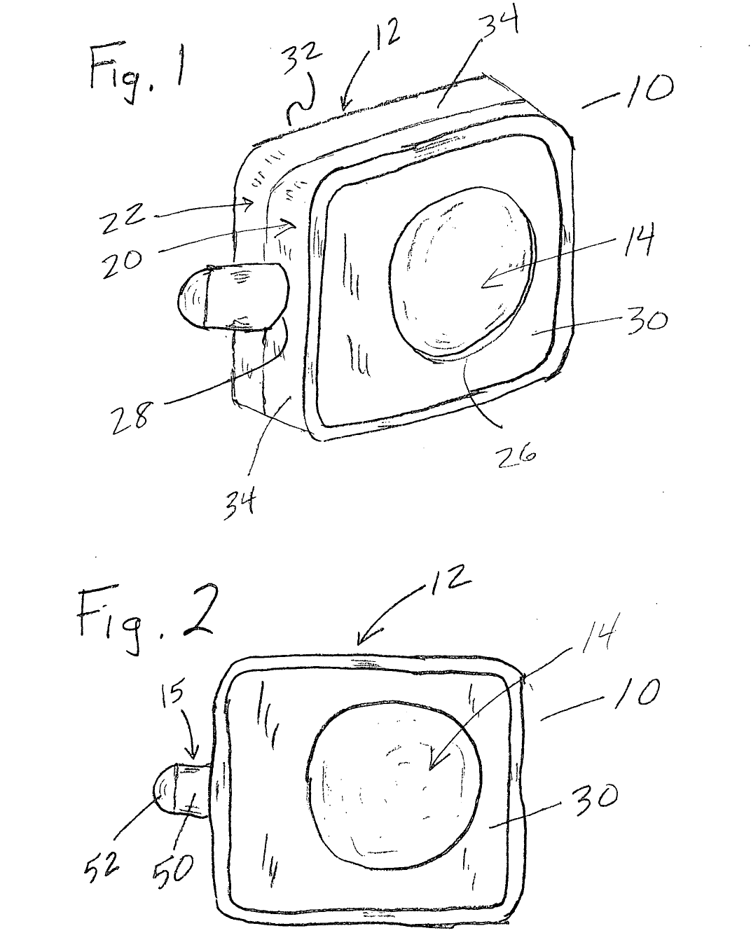

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

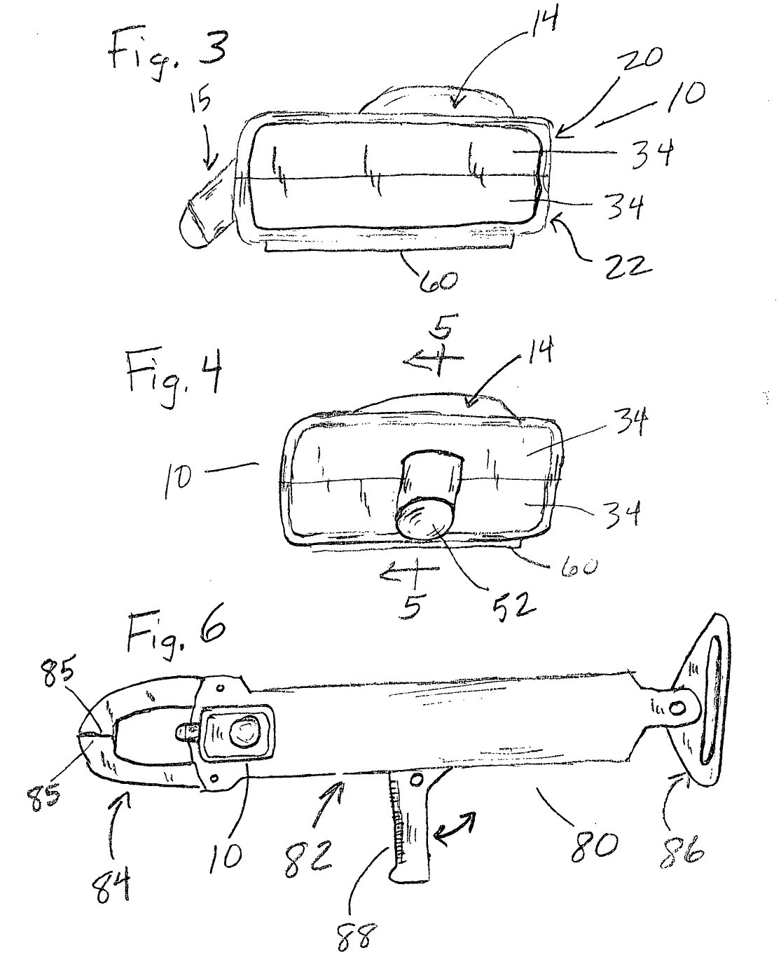

Having reference to the drawings, attention is directed first to FIG. 1, which discloses the archery release aid light apparatus of the invention, with the light apparatus being designated generally by the numeral 10. As can be appreciated by a comparison of FIGS. 1, 3, 4, and 5, the archery release aid light apparatus includes a housing 12, a button 14, and a lighting device 15. The housing has a first outer wall component 20 and a second outer wall component 22. The two outer wall components are preferably snap-fit and glued together. The housing of the apparatus is preferably fabricated from a rigid plastic, but could also be made from an elastomeric (rubber) material, metal, or a housing comprised of a conformal coating. The housing when assembled forms an interior cavity 24 where the power supply 13 is retained in a recessed portion of the second wall component 22 having an area slightly greater than that of the power supply. The power supply or source utilizes one or multiple batteries (coin cell, button cell, primary battery or rechargeable battery, etc.).

In the first outer wall component is a first aperture 26 shown as being slightly offset from the center of the top wall 30. The sidewall 34 when assembled features a second aperture 28 that when attached to the archery release aid faces in the direction the arrow is to fly. The second aperture when the archery releasse aid 10 is assembled, has projecting therethrough the lighting device 15.

The lighting device preferably is a single light emitting diode (LED). Depending upon the specific application, the lighting device could be constructed with one or multiple LEDs (lamp-type or SMT, etc.), one or multiple LEDs of the same color (ultraviolet thru infrared; 250 nm˜1550 nm, including white), one or multiple LEDs of different colors (ultraviolet thru infrared; 250 nm˜1550 nm, including white), one or multiple multi-chip LEDs with single color dice (ultraviolet thru infrared; 250 nm˜1550 nm, including white), one or multiple multi-chip LEDs with different color dice (ultraviolet thru infrared; 250 nm˜1550 nm, including white), one or multiple white LEDs (blue die phosphor converted, UV die phosphor converted, bi-chromatic converted, RGB converted, etc.), one or multiple incandescent lamps (radial, axial, or SMT, etc.), one or multiple incandescent lamps with colored boot to achieve specific colors, or one or multiple incandescent lamps with colored glass to achieve specific colors.

The LED is positioned within the housing at an angle such that the directional light coming out of the LED illuminates where a bowstring is held by the jaws of a release aid when the housing is attached to the body of the release aid at a distance of 1″ to 2″ away. The illumination level is sufficient to light the release aid jaws and some small distance beyond but not of sufficient illumination to be seen by the target.

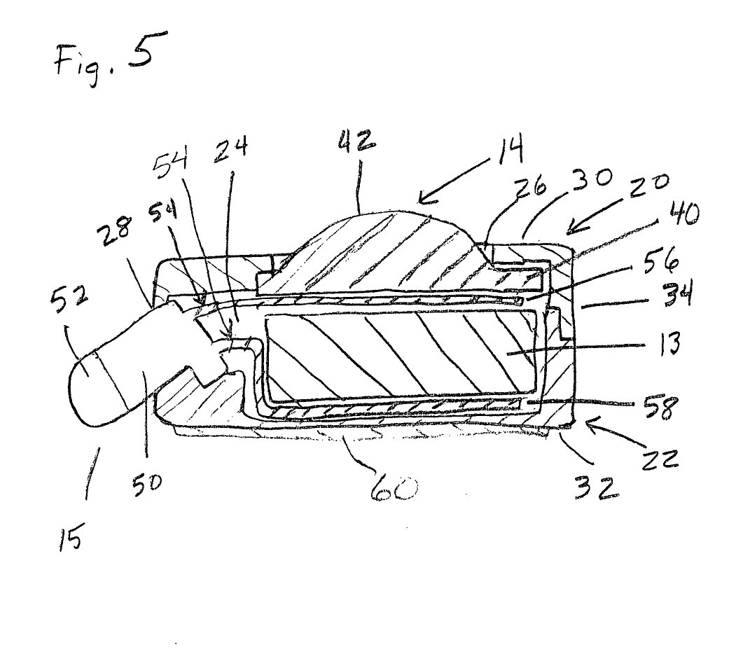

The lighting device has a lighting device housing 50, a light emitting member 52 and circuitry 54 as can be appreciated from FIG. 5. The lighting device is activated by a button 14 which could be a raised elastomeric (rubber) button cap, a flat elastomeric (rubber) button cap, a raised hard plastic button cap, a flat hard plastic button cap, or a direct mounted switch or remote mounted switch. As shown in the drawings, the preferred embodiment of the button has a button base portion 40 retained in the cavity directly adjacent the first outer wall component 20.

Intermittent electrical contact is made between the battery 13 and the LED wire leads 56, 58 by means of a button cap 14. In the preferred embodiment and use of the invention, the archer applies downward force to the exterior surface portion 42 of the button cap which presses the LED wire leads to the battery contacts, thereby completing the circuit and lighting the LED. Removing the applied force from the button cap releases pressure upon the LED wire leads and battery, thereby interrupting the electrical contact and turning off the LED. The top of the power source comes into contact with circuitry first component 56 while the circuitry second component 58 comes into contact with the bottom of the power supply and the bottom wall 32.

Attachment of the lighting device to the archery aid is accomplished by attachment means 60. For permanent attachment, the body of the lighting device is affixed to the release aid via a double-back adhesive tape. For non-permanent attachment, the body of the lighting device is preferably affixed to the release aid via hook and loop fastening means having adhesive backing. Due to the compact size and construction, the lighting device could be attached to any style release aid used in the industry; strap-on wrist type, hand-held, thumb release, third finger trigger, back tension, or automatic trigger style.

In addition, the invention could include a current limiting device, a constant current device, a voltage regulating device, dimming capability (mechanical, resistive, current-controlled, or voltage controlled, etc.), a momentary switch (normally open or normally closed, etc.), a single pole single throw (SPST) switch (normally open or normally closed, etc.), a capacitive switch (normally open or normally closed, etc.), an optical switch (normally open or normally closed, visible or infrared, etc.), or a radio frequency activated switch (normally open or normally closed, Bluetooth, etc.).

Although the power source is preferably inside the housing, it could be mounted remotely. Other possible components of the apparatus could include a printed circuit board (PCB), a flex circuit (flexible printed circuit), or a rigid-flex circuit (rigid-flexible printed circuit). Additionally, with respect to the lighting device, optional components could include a secondary optic to direct or shape the light (reflector, plastic lens, glass lens, etc.), a light pipe to direct or shape the light (plastic or glass, etc.), a light guide to direct or shape the light (plastic or glass, etc.), or fiberoptic cable to direct or shape the light (plastic or glass, etc.).

The archery release aid 80 has a body or archery release aid housing 82, jaws 84 with gripping surfaces 85, a wrist strap attachment means 86, and a trigger 88. The housing 12 could be mounted to the outer surface of the archery release aid 80 by hook and loop fastening means, double-back adhesive tape (foam tape, VHB tape, etc.), mechanical hardware (screws, bolts, etc.), magnets (flexible magnetic tape, rare earth magnets, etc.), or suction cup(s).

In the assembled condition, there is provided a small, light-weight, portable lighting device that attaches to an archery release aid providing sufficient illumination to assist the archer in attaching the release aid to the bowstring or loop and/or the arrow to the nocking position of the bowstring. The lighting device could be used for many other applications within the archery and hunting industry. For example, it could be used as a bow sight light, a small portable flashlight with extremely limited illumination power, or a quiver light. While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. An archery release aid light apparatus comprising
a housing having a first outer wall component and a second outer wall component, said first and second outer wall components attached to one another, said housing having an interior cavity, said housing having a first aperture and a second aperture,
a power supply located inside said housing,
a depressable button, said button retained in said cavity, said button visible through said first aperture, and
a lighting device, said lighting device having a lighting device housing, a light emitting member, and circuitry, said circuitry having a first component and a second component, said first component extending from said lighting device to a location intermediate said power supply and said button, said second component extending from said lighting device to a location intermediate said power supply and said second outer wall component, said lighting device housing projecting through said second aperture.

2. The archery release aid light apparatus according to claim 1, wherein said first aperture is of a first area and said second aperture is of a second area, said first aperture being larger in area than said second aperture.

3. The archery release aid light apparatus according to claim 1, wherein said housing has a top wall, a bottom wall, and a side wall, with the top wall being generally rectangular in shape.

4. The archery release aid light apparatus according to claim 3, wherein said first aperture is located in said top wall and said second aperture is located in said side wall.

5. The archery release aid light apparatus according to claim 4, wherein said first aperture is larger in area than said second aperture.

6. The archery release aid light apparatus according to claim 1, wherein said button projects through said first aperture.

7. The archery release aid light apparatus according to claim 1, wherein said light emitting member is a light emitting diode.

8. The archery release aid light apparatus according to claim 1, wherein said first component and said second component are each conductors.

9. An archery release aid apparatus having secured thereto a light apparatus with the light apparatus comprising
a housing having a first outer wall component and a second outer wall component, said first and second outer wall components attached to one another, said housing having an interior cavity, said housing having a first aperture and a second aperture,
a power supply located inside said housing,
a depressable button, said button retained in said cavity, said button visible through said first aperture, and
a lighting device, said lighting device having a lighting device housing, a light emitting member, and circuitry, said circuitry having a first component and a second component, said first component extending from said lighting device to a location intermediate said power supply and said button, said second component extending from said lighting device to a location intermediate said power supply and said second outer wall component, said lighting device housing projecting through said second aperture.
